(19) United States
(12) Patent Application Publication
(10) Pub. No.: US 2026/0233571 A1
(43) Pub. Date: Aug. 13, 2026

(54) SUSPENSION FRAME COVER SYSTEM AND METHOD

(71) Applicants: NISSAN NORTH AMERICA, INC., Franklin, TN (US); NISSAN MOTOR CO., LTD., Yokohama-shi (JP)

(72) Inventors: Kyle JOSLYN, Wixom, MI (US); Atsuji OKAWA, Matsuda-machi (JP); Hiroki YONEKAWA, Zama-shi (JP); Keisuke OHARA, Isehara-shi (JP)

(21) Appl. No.: 19/048,240

(22) Filed: Feb. 7, 2025

(51) Int. Cl. B60G 99/00

(52) U.S. Cl. CPC B60G 99/002

(57) ABSTRACT

A suspension frame cover system includes a cover body. The cover body includes a top surface and first and second side surfaces, the cover body being sized and configured to attach to and cover a portion of a suspension frame of a vehicle. The cover body enables liquids to drain from the top surface of the cover body, protecting the suspension frame of a vehicle.

### BACKGROUND

### Technical Field

The present disclosure generally relates to a suspension frame cover system and method. More specifically, the present disclosure relates to a suspension frame cover system that protects a portion of the suspension frame from rust.

### Background Information

Suspension frames from vehicles can be exposed to harsh environments. For example, the suspension frames for vehicles, along with any external portion of a vehicle, can be exposed to water, salt, dirt and other natural and human made materials. These materials can cause harm, such as rust, to the suspension. This harm can reduce the life of the suspension frame and require replacement or repair of the suspension parts. In some conventional suspension frames, a coating material can be applied to parts of the suspension frame.

### SUMMARY

It has been determined that the conventional manner to improve the life of the suspension frame is inadequate and difficult to affect. In view of the state of the known technology, one aspect of the present disclosure is to provide a suspension frame cover system, comprising a cover body. The cover body includes a top surface and first and second side surfaces, the cover body being sized and configured to attach to and cover a portion of a suspension frame of a vehicle.

Another aspect of the present disclosure is to provide a method of protecting a portion of a suspension of a vehicle, the method comprising providing a cover body, the cover body including a top surface and first and second side surfaces, and attaching the cover body to a portion of a suspension frame of a vehicle, so as to protect the portion of the suspension frame from rust.

The suspension frame cover system according to this aspect protects a portion of the suspension system from external material and improves the life of the suspension. In particular, the suspension frame cover system and method reduces or prevents rust from occurring on the portion of the suspension thereby increasing the life of the suspension. Moreover, the suspension frame cover system is easily attachable to the suspension frame, thereby facilitating assembly of the suspension on the vehicle.

Also, other objects, features, aspects and advantages of the disclosed suspension frame cover system will become apparent to those skilled in the art from the following detailed description, which, taken in conjunction with the annexed drawings, discloses preferred embodiments of the suspension frame cover system.

### BRIEF DESCRIPTION OF THE DRAWINGS

Referring now to the attached drawings which form a part of this original disclosure, an illustrative embodiment is shown.

FIG. 1 is a side view of a vehicle wheel with an embodiment of the suspension frame cover system attached to a portion of the suspension frame.

FIG. 2 is an enlarged perspective view of the view of the suspension frame cover system illustrated in FIG. 1 attached to a portion of the suspension frame.

FIG. 3 is a side perspective view of the suspension frame cover system illustrated in FIG. 1 attached to a portion of the suspension frame with portions of the suspension system removed.

FIG. 4 is a side elevational view of the suspension frame cover system illustrated in FIG. 3.

FIG. 5 is a front elevational view of the suspension frame cover system illustrated in FIG. 3.

FIG. 6 is an exploded perspective view of the suspension frame cover system illustrated in FIG. 3.

FIG. 7 is an exploded front view of the suspension frame cover system illustrated in FIG. 3.

FIG. 8 is a top perspective view of the cover body of the suspension frame cover system of FIG. 1.

FIG. 9 is a bottom perspective view of the cover body of the suspension frame cover system of FIG. 1.

FIG. 10 is a top view of the cover body of the suspension frame cover system of FIG. 1.

FIG. 11 is a bottom view of the cover body of the suspension frame cover system of FIG. 1.

FIG. 12 is a right side view of the cover body of the suspension frame cover system of FIG. 1.

FIG. 13 is a rear view of the cover body of the suspension frame cover system of FIG. 1.

FIG. 14 is a front view of the cover body of the suspension frame cover system of FIG. 1.

FIG. 15 is a cross sectional view of the cover body of the suspension frame cover system taken along lines 15-15 of FIG. 14.

### DETAILED DESCRIPTION

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

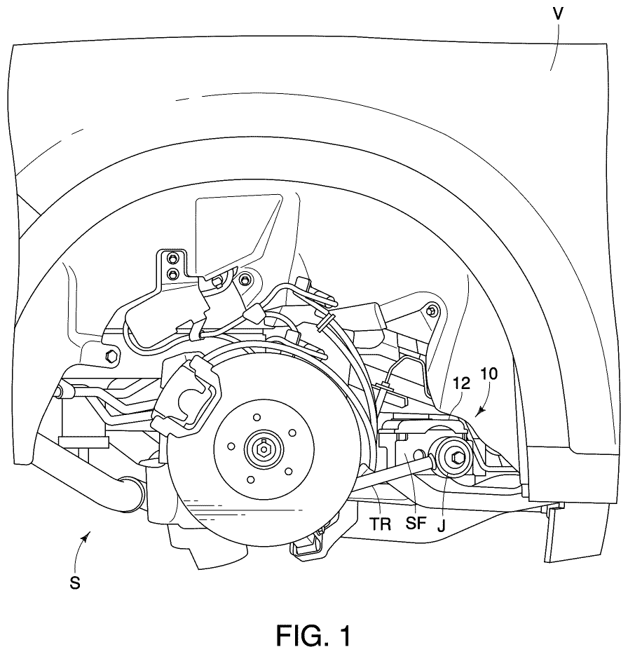

Referring initially to FIG. 1, a suspension frame cover system 10 is illustrated in accordance with a first embodiment. The suspension frame cover system 10 includes a cover body 12 that is configured to be placed on top surface TS of a portion P of the suspension frame SF.

As can be understood, the suspension system S of a vehicle V can include a springs, shock absorbers, a frame and linkages that connects a vehicle V to its wheels and allows relative motion between the two. Suspension systems must support both road holding/handling and ride quality. The suspension system S is crucial for maintaining consistent contact between the road wheel and the road surface, as all forces exerted on the vehicle V by the road or ground are transmitted through the contact surface of the tires. Any damage to the suspension system S can significantly negatively impact the ride and the integrity of the vehicle V.

As can be understood, the suspension system S, including the suspension frame SF and/or any external portion of a vehicle V, can be exposed to water, salt, dirt and other natural and human made materials. These materials can cause harm, such as rust, to the suspension frame SF or even failure of the suspension frame SF. Thus, the ride quality of the vehicle V and the integrity of the vehicle V may be reduced.

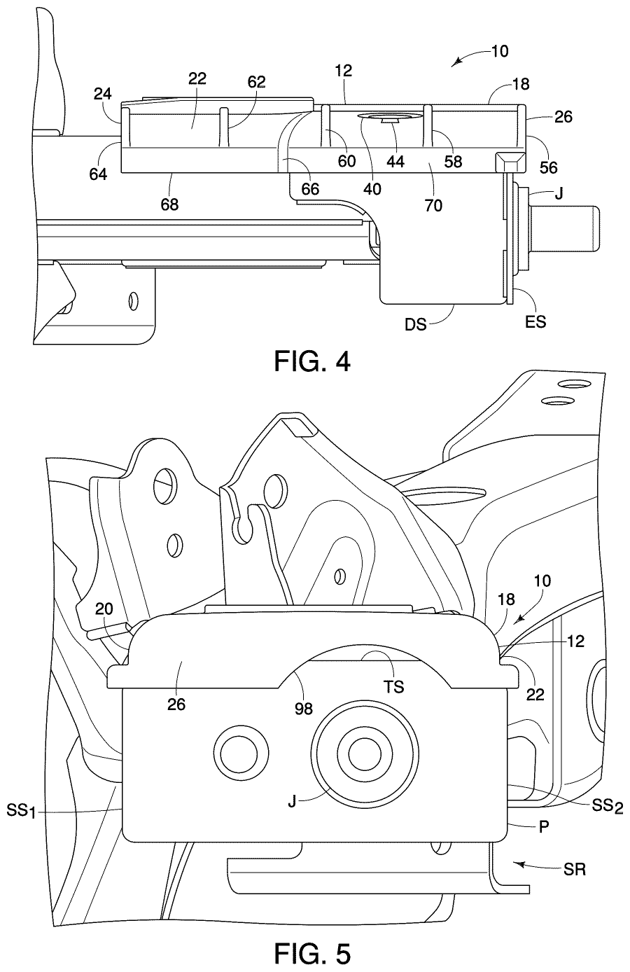

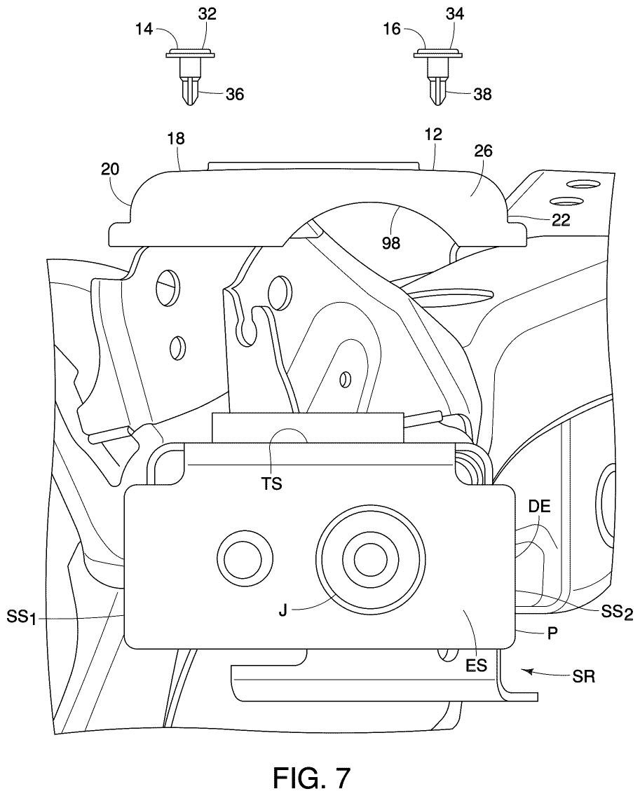

Accordingly, the configuration and positioning the of the suspension frame cover system 10 according to the present disclosure can improve the life of the suspension frame SF, which in turn can improve ride quality and the integrity of the vehicle V. As illustrated in FIGS. 1-7, the suspension frame cover system 10 is attached to a top surface TS of the a portion P of the suspension frame SF. The suspension frame cover system 10 can include first and second fasteners 14 and 16 that attach the cover body 12 to the portion P of the suspension frame SF.

In one embodiment, the cover body 12 includes a top surface 18 and first and second side surfaces 20 and 22. Thus, the cover body 12 covers the top surface TS of the portion P of the suspension frame SF and at least a portion of the first and second side surfaces SS₁ and SS₂ of the portion P of the suspension frame SF. Further, the cover body 12 can include third and fourth surfaces 24 and 26. The third surface 24 is configured to be positioned at a proximal side PS of the portion P of the suspension frame SF, while the fourth surface 26 is configured to be disposed at the distal end DE of the portion P of the suspension frame SF and at least partially covers the end surface ES of the portion P of the suspension frame SF.

It is noted that the cover body 12 can have other configurations that enable the cover system 10 to be disposed on different elements of the suspension frame SF and cover various aspects and portions of the suspension frame SF.

The top surface 18 of the cover body 12 includes first and second openings 28 and 30 configured to receive the first and second fasteners 14 and 16 to attach the cover body 12 to the portion P of the suspension frame SF. The first and second openings 28 and 30 are positioned so as to be aligned with first and second openings O₁ and O₂ in the portion P of the suspension frame SF. In this embodiment the first and second fasteners 14 and 16 can pass through the first and second openings O₁ and O₂ in the portion P of the suspension frame SF. It is noted that the suspension frame cover system 10 can include one two or more fasteners and the illustration of the first and second fasteners 14 and 16 is simply one embodiment.

Here, the first and second fasteners 14 and 16 include a head portion and a shaft portion. The shaft portion enters the first and second openings in the cover body 12 and the first and second openings in the first and second openings in the portion P of the suspension frame SF. In other words, the first and second fasteners 14 and 16 are configured to pass through the first and second openings 28 and 30 in the top surface 18 of the cover body 12 and fasten to the portion P of the suspension frame SF.

The head portions 32 and 34 of the first and second fasteners 14 and 16 can have diameter that is greater than the shaft portions 36 and 38 of the first and second fasteners 14 and 16 and the first and second openings in the cover body 12. The shaft portions 36 and 38 can be configured to be snap fitted into the opening in the portion P of the suspension frame SF. Alternatively, the shaft portions 36 and 38 can include threads that enable the first and second fasteners 14 and 16 to be threaded in the first and second openings O₁ and O₂ in the portion P of the suspension frame SF. However, the first and second fasteners 14 and 16 can be any type of fasteners that enables the cover body 12 to be attached to the portion P of the suspension frame SF. In one embodiment, the suspension frame cover system 10 does not include fasteners and is affixed or attached to the portion P of the suspension frame SF using any suitable fasteners or fastening system or using a friction fit or in any suitable manner.

In one embodiment, the first and second openings O₁ and O₂ in the portion P of the suspension frame SF are openings that are formed in the manufacturing of the suspension frame SF. However, the first and second openings O₁ and O₂ in the portion P of the suspension frame SF can be formed for the purpose of attaching the cover body 12 to the portion P of the suspension frame SF or for any other reason or in any manner desired.

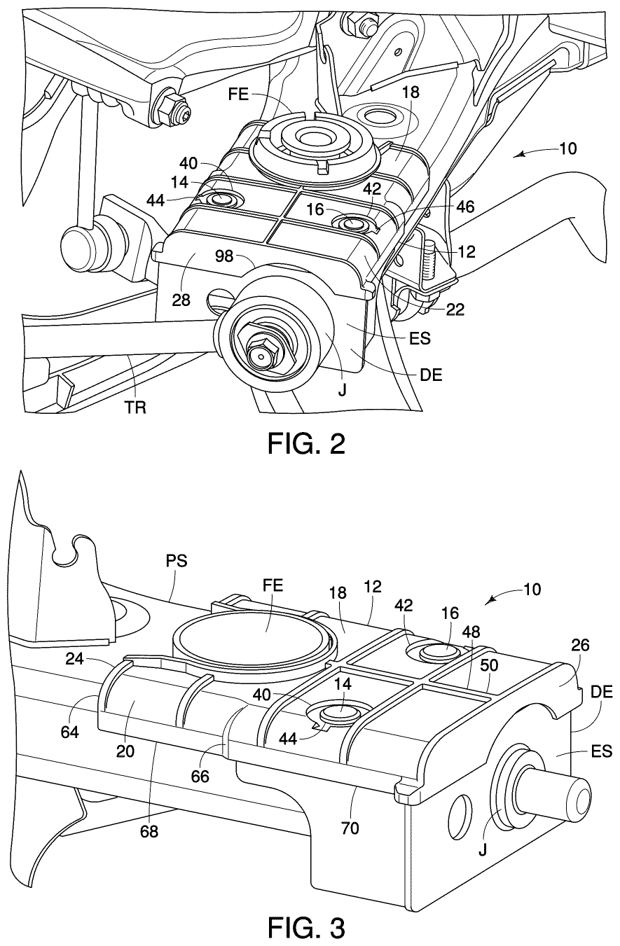

In one embodiment, the first and second openings 28 and 30 are disposed in first and second recessed portions 40 and 42 of the top surface 18 of the cover body 12. The recessed portions 40 and 42 can be generally circular and have a configuration that is substantially the same as the configuration of the head portions 32 and 34 of the first and second fasteners 14 and 16. As illustrated in FIGS. 2 and 3, the diameter of the recessed portions 40 and 42 can be slightly larger than the outer diameters of the head portions 32 and 34. This configuration enables the head portions 32 and 34 of the first and second fasteners 14 and 16 to be even or recessed relative to the top surface 18 of the cover body 12. Such a configuration can facilitate positioning and installation of the suspension frame cover system 10. Moreover, this configuration can reduce any protrusion of the first and second fasteners 14 and 16 which could cause damage to the first and second fasteners 14 and 16 and/or the suspension frame cover system 10.

As illustrated in FIGS. 2-4 and 6, the recessed portions 40 and 42 can include a drains 44 and 46. The drain is preferably disposed at the outer periphery of the recessed portions 40 and 42 and are disposed adjacent the first and second sides of the cover body 12. In one embodiment the drains are generally rectangular and extend from the periphery of the recessed portions 40 and 42 along the top surface 18 and into the first and second side surfaces 20 and 22. The configuration of the drains 44 and 46 in the recessed portions 40 and 42 enables fluid, such as water or other material from the road or the vehicle V to drain from the recessed portions 40 and 42. This drainage through the drains 44 and 46 can prolong the life of the cover body 12 and improve overall performance of the suspension frame cover system 10.

The top surface 18 and the first and second side surfaces 20 and 22 also have a configuration that enables fluid, such a water or any other liquids, to drain from the top surface 18 of the cover body 12. In one embodiment, the top surface 18 has a sloped configuration to enable liquids to drain. In this embodiment, the top surface 18 can have a highest point 48 in the middle of the top surface 18. This highest point 48 can be at the center rib 50 that extends in the longitudinal direction L. The center rib 50 can divide the top surface 18 into first and second sides 52 and 54 and enables any fluid to drain from the center rib 50 along the top surface 18 and to the first and second side surfaces 20 and 22.

The top surface 18 can also include lateral ribs 56, 58, 60, 62 and 64 that extend from the center rib 50 to the first and second side surfaces 20 and 22. These lateral ribs 56, 58, 60, 62 and 64 can enable channeling of the fluids to facilitate fluid run off. Thus, the ribs 50 and 56, 58, 60, 62 and 64 can improve the life and overall operation of the suspension frame cover system 10.

The first and second side surfaces 20 and 22 can have a curved or arcuate configuration adjacent the top surface 18. This curving of the cover body 12 from the top surface 18 to the first and second side surfaces 20 and 22 can facilitate fluid run off. Thus, the curved or arcuate configuration can improve the life and overall operation of the suspension frame cover system 10.

The first and second side surfaces 20 and 22 include a stepped portion 66. The stepped portion 66 is disposed between the proximal portion 68 and the distal portion 70 of the cover body 12. The distal portion 70 is wider than the proximal portion 68. Accordingly, the cover body 12 can have a configuration that is congruent with the portion P of the suspension frame SF. Moreover, such a configuration facilities a friction fit or a liquid proof fit between the cover body 12 and the portion P of the suspension frame SF.

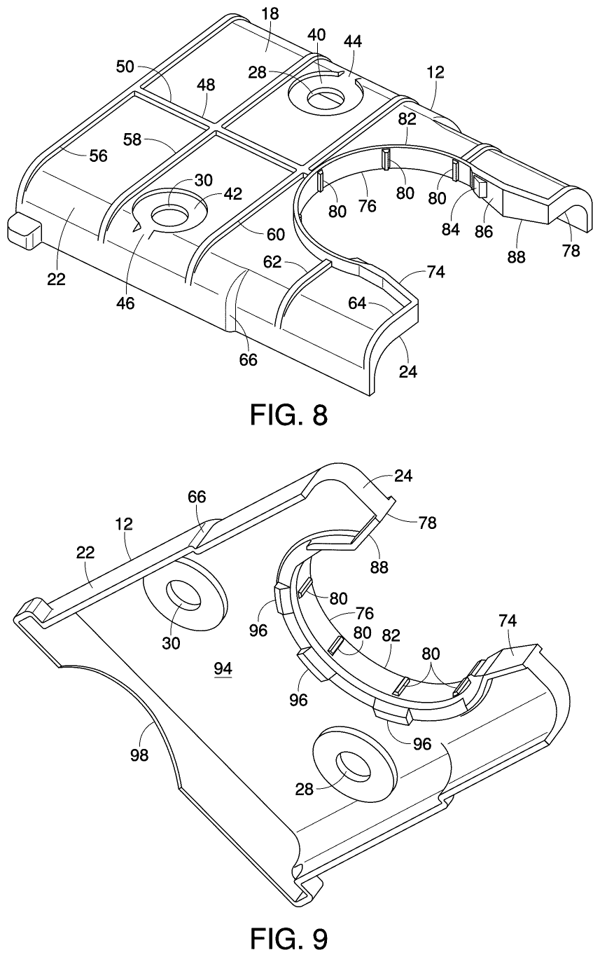

As illustrated in FIG. 8-10, the cover body 12 includes the third surface 24 and the fourth surface 26. The third surface 26 includes an opening 74 to enable the cover body 12 to partially surround a fastening element FE of the portion P of the suspension frame SF. The opening 74 in the third surface 26 is arcuate or has an arcuate surface 76 and extends from a perimeter 78 of the cover body 12 inwardly on the top surface 18 of the cover body 12. The arcuate surface 76 of the opening 74 in the third surface 26 includes ribs 80. In this embodiment, the arcuate surface includes 5 ribs 80 spaced an intervals along the arcuate surface 76. The intervals can be evenly spaced, if desired. The opening 74 can include a first portion 82 that is one example of the arcuate portion and a second portion 84, the second portion 84 being narrower than a widest part of the first portion.

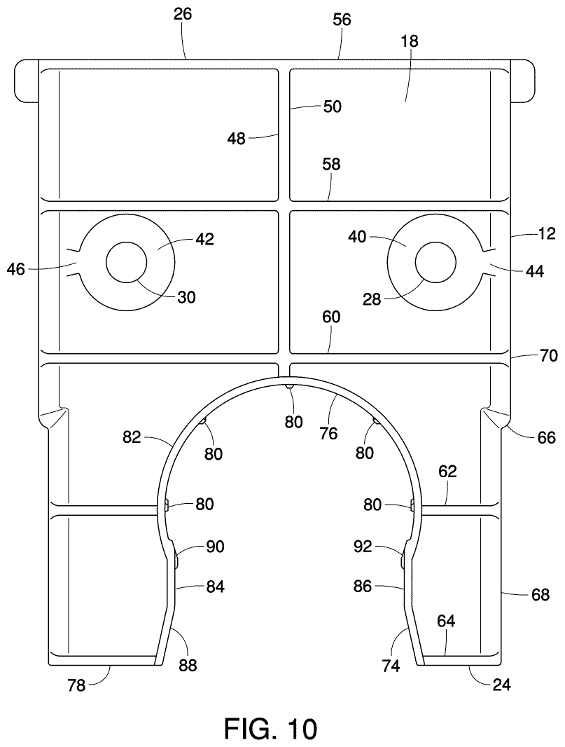

In one embodiment the second portion 84 includes a first part 86 and a second part 88, the first part 86 is adjacent the arcuate surface 76 and the second part 88 extends from the first part 86 to the outer perimeter 78 of the cover body 12. As illustrated in FIG. 10, the second part 88 can have a width that increases from the arcuate surface 76 to the perimeter of the cover body 12. The width of the first part 86 can be substantially consistent. This configuration can enable the cover body 12 to snap fit to the fastening element FE of the portion P of the suspension frame SF. This snap fit can increase the attachment of the cover body 12 to the portion P of the suspension frame SF.

At the transition of the arcuate surface 76 to the first portion 86, a first protrusion 90 and a second protrusion 92 are disposed. The first and second protrusions 90 and 92 have an inclined shaped, so as to have an increased width in a direction of the perimeter 78 of the cover body 12. The first and second protrusions 90 and 92, along with the ribs 80 facilitate an interference fit between the cover body 12 and the fastening element FE of the portion P of the suspension frame SF.

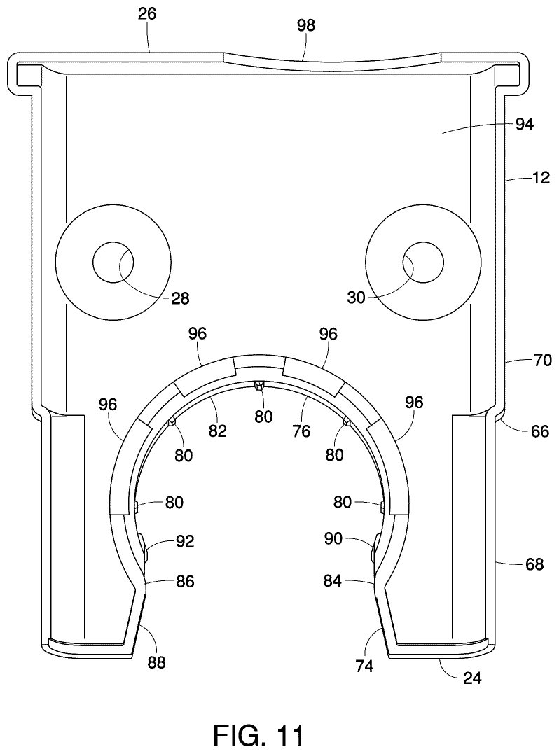

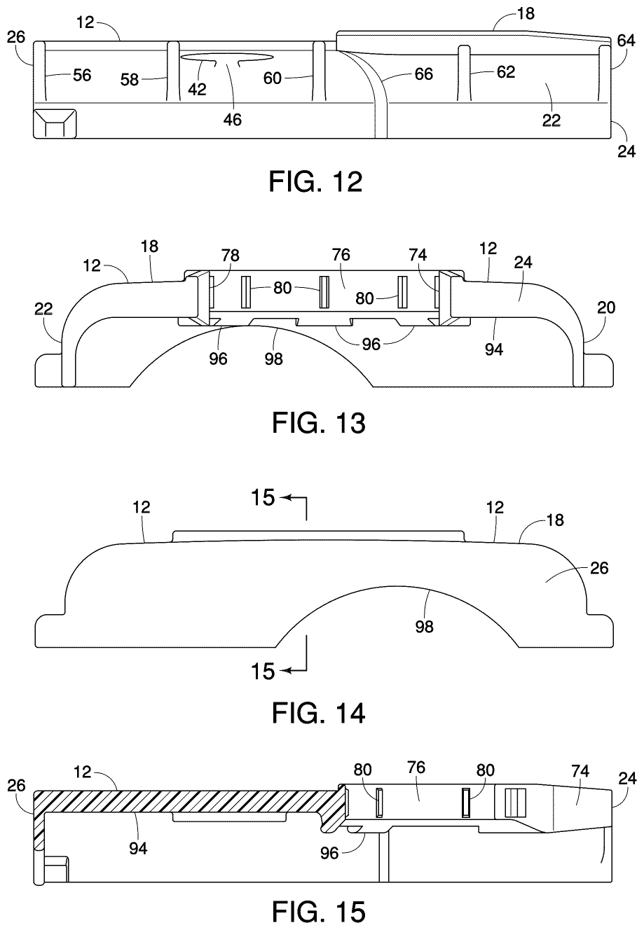

As shown in FIGS. 9 and 11 the bottom surface 94 of the cover body 12 includes protrusions 96 surrounding the first part (arcuate portion) 82 formed by the arcuate surface 76. The protrusions 96 extend in the circumferential direction around the first part (arcuate portion) 82 and are configured to contact the top surface TS of the portion P of the suspension frame SF.

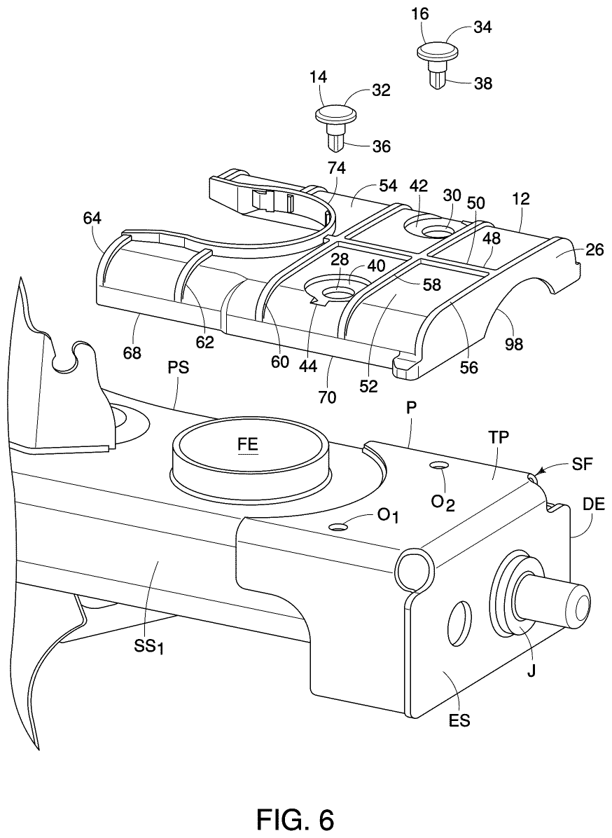

As shown in FIGS. 6 and 14, the fourth surface 26 of the cover body 12 is a distal surface and extends down from the top surface 18 of the cover body 12 to cover the distal surface of the portion P of the suspension frame SF. The fourth surface 26 includes an arcuate cut out 98 to enable a fit around a joint J for a tie rod (or suspension link) TR of the suspension system S system. The arcuate cut out 98 is configured to enable placement of the cover body 12 on the portion P of the suspension frame SF; however, the cover body does not necessarily need to have the arcuate cut out 98 and the fourth surface 26 of the cover body 12 can be configured in any suitable manner to enable the cover body to be positioned on the portion P of the suspension frame SF.

As can be understood, the cover body 12 when fit to the portion P of the suspension frame SF provides protection the portion P of the suspension frame SF and protects the portion P of the suspension frame SF from liquids and other road elements. Moreover, the specific configuration described above is an example of a structure of the cover body 12, and the cover body 12 can be designed and configured in any manner suitable to cover the portion P of the suspension frame SF.

FIG. 6 is an exploded version of the suspension frame cover system 10 prior to being attached to the portion P of the suspension frame SF. In this embodiment, the suspension frame cover system 10 can be attached to the vehicle V by first providing a cover body 12 as described herein. For example, the cover body 12 can include the top surface 18 and the first and second side surfaces 20 and 22. The cover body 12 can be attached to the portion P of the suspension frame SF of the vehicle V, so as to protect the portion P of the suspension frame SF from rust. In one embodiment, when the cover body 12 is attached to the portion P of the suspension frame SF, fasteners 14 and 16 can be passed through the openings 28 and 30 in the top surface 18 of the cover body 12 to attach the cover body 12 to the portion P of the suspension frame SF. The fasteners 14 and 16 can be attached to the portion P of the suspension frame SF.

Further, as discussed herein, when attaching the cover body 12 to the portion P of the suspension frame SF, the opening 74 in the third surface 26 can partially surround the fastening element FE of the portion P of the suspension frame SF. As described above, the opening 74 in the third surface 26 includes ribs 80, and the ribs 80 contact the fastening element FE of the portion P of the suspension system S.

When attached to the portion P of the suspension system S, the cover body 12 enables liquids to drain from the top surface 18 of the cover body 12, since the cover body 12 has a sloped configuration. Moreover, as described herein, the fasteners 14 and 16 are disposed in recessed portions 40 and 42 on the top surface of the cover body 12, and the recessed portions 40 and 42 include drains 44 and 46. Thus, the cover body 12 further facilitates liquids draining from the top surface 18 of the cover body 12.

The cover body 12 according to the present disclosure is an improved system to protect a suspension frame SF from rust or damage during use.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle V equipped with the *. Accordingly, these terms, as utilized to describe the present invention should be interpreted relative to a vehicle V suspension frame SF equipped with the suspension frame cover system 10.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the vehicle field from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A suspension frame cover system, comprising:
a cover body including a top surface and first and second side surfaces, the cover body being sized and configured to attach to and cover a portion of a suspension frame of a vehicle.

2. The suspension frame cover system according to claim 1, wherein the top surface of the cover body includes an opening configured to receive a fastener to attach the cover body to the portion of the suspension frame.

3. The suspension frame cover system according to claim 2, wherein the opening is disposed in a recessed portion of the top surface of the cover body.

4. The suspension frame cover system according to claim 3, wherein the recessed portion includes a drain.

5. The suspension frame cover system according to claim 2, wherein the fastener is configured to pass through the opening in the top surface of the cover body and fastens to the portion of the suspension frame.

6. The suspension frame cover system according to claim 1, wherein the cover body includes a third surface, the third surface including an opening to enable the cover body to partially surround a fastening element of the portion of the suspension frame.

7. The suspension frame cover system according to claim 6, wherein the opening in the third surface is arcuate.

8. The suspension frame cover system according to claim 6, wherein a surface of the opening in the third surface includes ribs.

9. The suspension frame cover system according to claim 6, wherein the opening in the third surface includes a first portion that is arcuate and a second portion, the second portion being narrower than a widest part of the first portion.

10. The suspension frame cover system according to claim 1, wherein the top surface has a sloped configuration to enable liquids to drain.

11. A method of protecting a portion of a suspension of a vehicle, the method comprising:
providing a cover body, the cover body including a top surface and first and second side surfaces; and
attaching the cover body to a portion of a suspension frame of a vehicle, so as to protect the portion of the suspension frame from rust.

12. The method according to claim 11, wherein the attaching includes passing a fastener through an opening in the top surface of the cover body to attach the cover body to the portion of the suspension frame.

13. The method according to claim 12, wherein the opening in the top surface is disposed in a recessed portion of the top surface of the cover body.

14. The method according to claim 13, wherein the recessed portion includes a drain.

15. The method according to claim 12, wherein the attaching includes attaching the fastener to the portion of the suspension frame.

16. The method according to claim 11, wherein the cover body includes a third surface, the third surface including an opening, and the attaching includes attaching the cover body to the portion of the suspension frame such that the opening in the third surface partially surrounds a fastening element of the portion of the suspension frame.

17. The method according to claim 16, wherein the opening in the third surface is arcuate.

18. The method according to claim 16, wherein a surface of the opening in the third surface includes ribs.

19. The method according to claim 16, wherein the opening in the third surface includes a first portion that is arcuate and a second portion, the second portion being narrower than a widest part of the first portion.

20. The method according to claim 11, wherein the top surface has a sloped configuration to enable liquids to drain.
